(19) United States
(12) Patent Application Publication
(10) Pub. No.: US 2026/0232530 A1
(43) Pub. Date: Aug. 13, 2026

(54) ADAPTER DEVICE FOR COUPLING TO A MEDICAL VIAL

(71) Applicant: B. Braun Melsungen AG, Melsungen (DE)

(72) Inventors: Johannes Bolz, Kassel (DE); Florin Kopp, Schortens (DE); Christian Walter, Kassel (DE); Christian Hohmann, Edermuende (DE); Lara Berthold, Edertal (DE)

(21) Appl. No.: 19/154,105

(22) PCT Filed: Feb. 5, 2024
(86) PCT No.: PCT/EP2024/052731

§ 371 Date: Aug. 6, 2025

(30) Foreign Application Priority Data
Feb. 8, 2023 (DE) 10 2023 201 022.4

(51) Int. Cl. A61J 1/20

(52) U.S. Cl. CPC A61J 1/2055

(57) ABSTRACT

An adapter has a first housing end, a second housing end, a recess arranged between the housing ends, and an insertion opening at the first housing end for insertion of a vial into the recess. A plurality of spring arms are arranged in the recess and offset from one another in a circumferential direction. Each spring arm extends between a foot end fixedly connected to the housing and a latching end configured to latch onto the closure cap. The spring arms are deformable by axial insertion of a vial into the recess. Each latching end latches onto the closure cap in a form-fitting manner. The housing is closed in a circumferential direction at the axial height of the foot ends to form a ring portion.

### CROSS-REFERENCE TO RELATED APPLICATIONS

This application is the United States national phase entry of International Application No. PCT/EP2024/052731, filed on Feb. 5, 2024, and claims priority to German Application No. 10 2023 201 022.4, filed on Feb. 8, 2023. The contents of International Application No. PCT/EP2024/052731 and German Application No. 10 2023 201 022.4 are incorporated by reference herein in their entireties.

### FIELD

The invention relates to an adapter device for coupling to a medical vial which is closed with a closure cap, the adapter device having a housing with a first housing end, a second housing end lying opposite along a central longitudinal axis oriented in the axial direction, a housing recess arranged between the housing ends, and an insertion opening arranged at the first housing end and serving for axial insertion of the vial into the housing recess, and having a plurality of spring arms, which are arranged in the housing recess in a manner offset from one another in circumferential direction about the central longitudinal axis and each extend between a foot end, which is firmly connected to the housing, and a latching end, which is configured to latch with the closure cap, wherein the spring arms, in each case starting from their foot end, extend radially in the direction toward the central longitudinal axis and axially in the direction of the second housing end, as far as their latching end, as a result of which the spring arms are deformable by an axial insertion of the vial into the housing recess, so as to form-fittingly latch the latching ends axially with the closure cap in the direction of the housing opening.

### BACKGROUND

Such an adapter device is known from U.S. Pat. No. 6,875,205 B2. In the known adapter device, the housing has a plurality of slots offset from one another in the circumferential direction. Starting from the first end, i.e. the insertion opening, the slots extend axially in the direction of the second end. The housing of the adapter device is thus “open” or slotted in the circumferential direction and divided into a plurality of spring-elastic wall portions. In the known adapter device, the foot ends of the spring arms are each firmly connected to the spring-movable wall portions. Furthermore, the known adapter device is configured for coupling to medical vials of different sizes. Said spring arms are configured for coupling to a medical vial of a first size. The housing also has projections arranged in the housing recess, which projections are configured to latch with a vial of a larger, second size. In a state when coupled to the larger vial, the spring arms are plastically deformed and bent aside. To allow said plastic deformation, the spring arms have a reduced material cross section in the region of their foot ends. This is to ensure that, during insertion of the larger, second vial, the spring arms are bent plastically in the region of the foot end in accordance with the requirements.

### SUMMARY

The object of the invention is to make available an adapter device of the type mentioned at the outset, which has improved properties compared to the prior art and which in particular allows safe and reliable coupling.

This object is achieved by the fact that the housing is closed all the way round in the circumferential direction at the axial height of the foot ends in order to form a ring portion. The ring portion, closed in the circumferential direction, counteracts a radial deformation of the housing in the region of the foot ends. This prevents the foot ends from being moved radially outward relative to the central longitudinal axis under a bending load acting on the spring arms and/or a pressure load acting in the direction of the foot ends. In this way, a particularly advantageous elastic deformation behavior of the spring arms is achieved. In the coupled state, the latching ends are each axially and form-fittingly latched with the closure cap in the direction of the housing opening. An axial force acting on the latching ends in the direction of the housing opening thus causes pressure loading of the spring arms in the direction of the foot ends on the one hand and longitudinal bending on the other. If the vial is axially tensioned in the latched state, i.e. pulled out of the insertion opening/housing recess, the spring arms, on account of their radial and axial longitudinal extent, are subjected on the one hand to bending and on the other hand to pressure in the direction of their foot end. Due to the housing being “stiff” as a result of the ring portion, a radial yielding movement of the foot ends and thus of the whole of the spring arms is avoided. This ensures particularly reliable latching of the spring arms and prevents unwanted release of the vial. In addition, the design of the housing according to the invention, in combination with the longitudinal extent of the spring arms, causes a self-reinforcing effect of the latching under axial tensile loading. This is because the latching ends move radially in the direction of the central longitudinal axis along an imaginary arc-shaped bending line. By approximation of the latching ends to the central longitudinal axis, an additional radial force component can be generated on the vial, as a result of which the latching is additionally reinforced.

The positional and/or directional information used in this description can be understood as follows: “inner” means, in relation to the radial direction, to the inside and thus closer to the central longitudinal axis. “outer” means, in relation to the radial direction, to the outside and thus farther away from the central longitudinal axis. Terms such as “inner edge”, “inner side”, “inner surface”, “outer edge”, “outer side”, “outer surface” or the like should be understood accordingly. It is further assumed that, in order to couple the medical vial to the adapter device, the medical vial is inserted along the central longitudinal axis, with its closure cap first, through the insertion opening into the housing recess. The medical vial to be coupled is a container for medical substances in a liquid or dry state, as they are generally known in the field of human or veterinary medicine. The design and function of such medical vials is sufficiently familiar to those skilled in the art, and therefore further explanations of these are not needed. Preferably, the vial to be coupled complies with the standards ISO 8362-1 and/or ISO 8536-1. It will be understood that the medical vial to be coupled is not a constituent part of the adapter device according to the invention. Preferably, the adapter device is configured for coupling to medical vials of different sizes. Different sizes means in particular with different diameters and/or different axial lengths, especially of the respective closure cap. In one embodiment, for coupling to vials of different sizes, the plurality of spring arms are resiliently movable outward to different extents. In a further embodiment, different spring arms are available for coupling to different sizes of vials. Where features are explained in this description only with respect to one/the spring arm, what is said preferably applies, mutatis mutandis, to all of the spring arms. In one embodiment, the spring arms are uniformly offset from one another in the circumferential direction. In a further embodiment, groups of spring arms, for example pairs, are offset from one another in the circumferential direction, in particular uniformly. Preferably, there are at least three spring arms or three groups of spring arms. Of course, there may also be more than three spring arms or groups of spring arms, for example four, five, six, seven or even more. In a preferred embodiment, the ring portion is coaxial to the central longitudinal axis. In a preferred embodiment, the ring portion is circular.

In one embodiment of the invention, the spring arms each have a cross-sectional area which is at its maximum in the region of the foot end. In this way, the spring arms can each be loaded to a maximum extent in the region of their foot end, as a result of which plastic deformations and/or buckling in the region of the foot end is counteracted. In this way, a further improvement in deformation behavior of the spring arms is achieved. The embodiment with a maximum cross-sectional area at the foot side also includes embodiments in which the spring arms have a constant cross-sectional area over their length.

In a further embodiment of the invention, the spring arms each have a cross-sectional area which varies over their length, wherein the cross-sectional area, starting from the foot end, tapers in the direction of the latching end. Also in this embodiment, the cross-sectional area is at its maximum at the foot end. The tapering of the cross-sectional area in the direction of the latching end results in a particularly load-appropriate design and in a further improvement in the deformation behavior of the spring arms.

In a further embodiment of the invention, the spring arms each have a main axis of extent which, starting from an imaginary alignment oriented parallel to the central longitudinal axis, is inclined radially inward by an angle of between 10° and 50°, preferably of between 20° and 40°. The main axis of extent is oriented obliquely with respect to the axial direction and the radial direction. The main axis of extent can also be called the longitudinal axis. Preferably, the main axes of extent are each arranged in a plane spanned by the radial direction and the axial direction. These planes are offset and/or rotated relative to one another about the central longitudinal axis. Through said value ranges of the angle, a particularly advantageous deformation behavior of the spring arms can be achieved. In particular, said self-reinforcing effect can be particularly pronounced using a comparatively small angle.

In a further embodiment of the invention, the latching ends are each bent radially inward and have a first contact surface, which is at least predominantly oriented axially in the direction of the second housing end, and a second contact surface, which is at least predominantly oriented radially in the direction of the central longitudinal axis. As was explained at the outset, the latching ends, in the coupled state, are each axially and form-fittingly latched with the closure cap in the direction of the housing opening. In this embodiment, the first contact surface, in the coupled state, bears axially on a front end of the closure cap. In order to allow contact over as large a surface area as possible, the first contact surface is at least predominantly oriented axially in the direction of the second housing end, and thus, in the coupled state, in the direction of said front end of the closure cap. The second contact surface is at least predominantly oriented radially in the direction of the central longitudinal axis. In other words, the second contact surface faces radially inward. In the coupled state, the second contact surface preferably bears on a neck portion of the vial. The neck portion is axially spaced away from the closure cap in the direction of the insertion opening. Said orientation of the second contact surface allows contact over as large a surface area as possible. Preferably, the first contact surface and the second contact surface are orthogonal to each other.

In a further embodiment of the invention, the ring portion forms the first housing end, delimits the insertion opening, and has a set-down surface at the front end for setting the adapter device down. In other words, the ring portion in this embodiment forms a “lower” end of the adapter device. In this case, the adapter device can be placed, with the front-end set-down surface of the ring portion first, on a table or other support. In this embodiment, the foot ends of the spring arms are thus arranged directly at the first housing end. In this way too, it is possible to achieve advantages as regards the deformation behavior of the spring arms and of the housing as a whole.

In a further embodiment of the invention, the housing has a housing wall which extends between the first housing end and the second housing end and which has a plurality of recesses offset from one another in the circumferential direction, which recesses divide the housing wall into a plurality of wall portions and, in the region of the first housing end, are bridged by the ring portion, with the spring arms being arranged in the recesses. Preferably, the housing has a cylindrical basic shape, wherein the housing wall extends both axially and in the circumferential direction and has a radial wall thickness. The recesses can also be called apertures or windows. The recesses each extend in the circumferential direction and in the axial direction. Preferably, the recesses extend substantially over a total axial length/height of the housing. The recesses divide the housing walls into said plurality of wall portions. The wall portions are connected to one another circumferentially in the region of the first housing end by means of the ring portion. The ring portion bridges the recesses in the circumferential direction. In other words, the ring portion forms an axial boundary of the recesses. The spring arms are arranged in the recesses. This makes the spring arms easier to see, enabling medical personnel to particularly easily and reliably determine whether or not proper coupling to the vial to be coupled is present. Furthermore, this embodiment allows material savings in respect of the housing. This makes it possible to cut down on resources in the manufacture, storage and disposal of the adapter device, with associated cost savings.

In a further embodiment of the invention, the plurality of spring arms comprise first spring arms and different second spring arms, wherein the first spring arms are configured to latch with a first vial of a first size, and wherein the second spring arms are configured to latch with a second vial of a larger, second size. In this preferred embodiment of the invention, the adapter device is configured for selective coupling to medical vials of different sizes. For example, the first vial can be a vial with a standardized diameter of 28 mm. For example, the second vial can be a vial with a standardized diameter of 32 mm. Of course, it is also conceivable and possible to use other, preferably standardized, vial sizes. The first spring arms and the second spring arms preferably differ in terms of their size, in particular their length. Alternatively or in addition, the first spring arms and the second spring arms can differ in terms of their respective angle of inclination with respect to the central longitudinal axis. If the housing is provided with recesses, preferably a first spring arm and a second spring arm are arranged together in one of the recesses.

In a further embodiment of the invention, the first spring arms are longer than the second spring arms, as a result of which the latching ends of the first spring arms are positioned closer to the central longitudinal axis and closer to the second housing end than the latching ends of the second spring arms. This ensures that the first spring arms engage with the closure cap of the first vial and the second spring arms with the closure cap of the second vial in accordance with the requirements. Preferably, the foot ends of the first spring arms and the foot ends of the second spring arms are arranged at a common axial height, i.e. in a common axial plane.

The invention also relates to an arrangement having an adapter device according to one of the two preceding embodiments and having a first vial of a first size and/or a second vial of a larger, second size. As has been explained with respect to the two preceding embodiments of the adapter device, the adapter device of the arrangement is configured for selective coupling to the first vial and the second vial and for this purpose has first spring arms and second spring arms. In a first coupling state of the arrangement, the adapter device is coupled to the first vial. In an alternative, second coupling state, the adapter device is coupled to the second vial. As regards the features of the first vial and of the second vial, reference is made to the previous description in order to avoid repetition. The first vial has a first closure cap. The second vial has a second closure cap. The first closure cap and the second closure cap are different. In particular, the first closure cap has a smaller diameter than the second closure cap. Alternatively or in addition, the first closure cap has a smaller axial height/length than the second closure cap. The dimensions of the closure caps can be determined in particular from the aforementioned standards. In the first coupling state, the latching ends of the first spring arms are latched with the closure cap of the first vial and the latching ends of the second spring arms bear on a portion of the first vial that is axially spaced apart from the closure cap in the direction of the insertion opening and that can also be referred to as a neck portion. In the second coupling state, the latching ends of the second spring arms are latched with the closure cap of the second vial and the latching ends of the first spring arms are elastically spring-loaded radially outward under the action of the closure cap of the second vial and bear, in a radially inwardly biased state, on a jacket surface of the closure cap of the second vial. In the first coupling state, the second spring arms serve for (additional) stabilization of the latching connection between the first spring arms and the vial. In the second coupling state, the first spring arms serve for (additional) stabilization of the latching connection between the second spring arms and the second vial. Preferably, under the action of the closure cap, the first spring arms in the second coupling state are radially outwardly spring-loaded at least predominantly elastically, i.e. without any practically relevant plastic deformation components.

### BRIEF DESCRIPTION OF THE DRAWINGS

Further advantages and features of the invention will become clear from the following description of preferred exemplary embodiments of the invention, which are illustrated with the aid of the drawings.

FIG. 1 shows a schematic perspective view of an embodiment of an adapter device according to the invention.

FIG. 2 shows the adapter device according to FIG. 1 in a schematic plan view, with an axially oriented viewing direction;

FIG. 3 shows the adapter device according to FIGS. 1 and 2 in a schematic side view, with a radially inwardly oriented viewing direction;

FIGS. 4 and 5 show different use situations of the adapter device according to FIGS. 1 to 3, in which the adapter device is coupled to form an arrangement with a first vial of a first size (FIG. 4) and a second vial of a second size (FIG. 5); and

FIG. 6 shows an enlarged detail of the arrangement according to FIG. 5, illustrating the details of a latching connection between the adapter device and the second vial.

### DETAILED DESCRIPTION

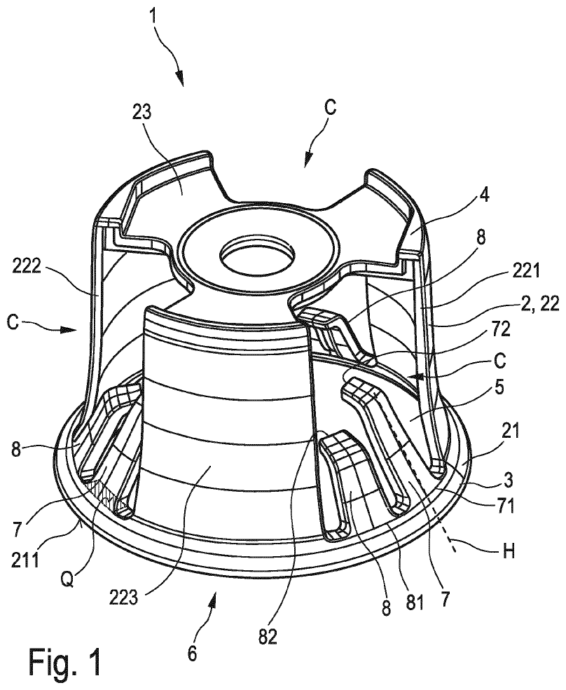

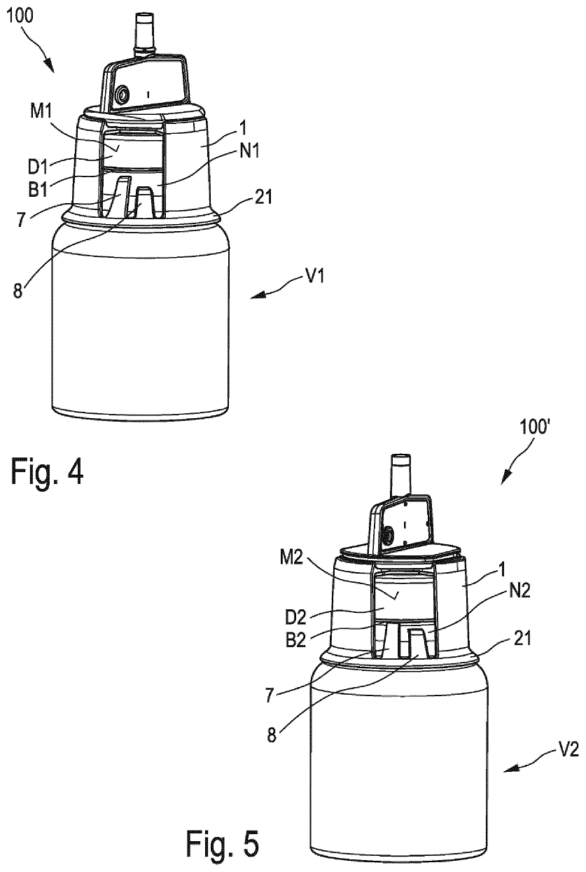

According to FIGS. 1 to 3, an adapter device 1 is configured for coupling to a medical vial V1, V2. In the coupled state, the adapter device 1 and said vial V1, V2 form an arrangement 100, 100′ as shown in FIGS. 4, 5 and 6.

In the embodiment shown, the adapter device 1 is configured for coupling to vials of different sizes. In particular, the adapter device 1 can be coupled selectively to a first vial V1 of a first size (see FIG. 4) and to a second vial V2 of a second size. Such a configuration of the adapter device for selective coupling to different sizes of vials is not provided in all embodiments and is therefore optional.

Vials are used for storing medical substances in liquid or dry form and are generally known in human and veterinary medicine. Vials are also known as “ampules”, “phials” or “pierceable injection bottles”. Vials are usually available in different standardized sizes, with vials of different sizes having different capacities and different (standardized) dimensions. In the present case, said vials V1, V2 comply with the standard ISO 8362-1 and/or ISO 8536-1.

The vials V1, V2 shown in FIGS. 4, 5 and 6 each have a closure cap D1, D2, which in a known manner is mounted fluid-tight on a respective neck region N1, N2 of the respective vial V1, V2. The dimensions of the closure caps D1, D2 and of the neck regions N1, N2 are also standardized. In the present case, the second vial V2 is larger than the first vial V1, wherein in particular an axial dimension (without reference sign) and/or a diameter (without reference sign) of the second closure cap D2 is greater than the relevant dimension of the first closure cap D1. In addition, the closure cap can also be called a “closure lid” or “crimped cap”. As the basic structure and function of the vials V1, V2 are known to a person skilled in the art, further explanations can be omitted.

The adapter device 1 has a housing 2 and a plurality of spring arms 7, 8.

The housing 2 has a first housing end 3, a second housing end 4, a housing recess 5 and an insertion opening 6.

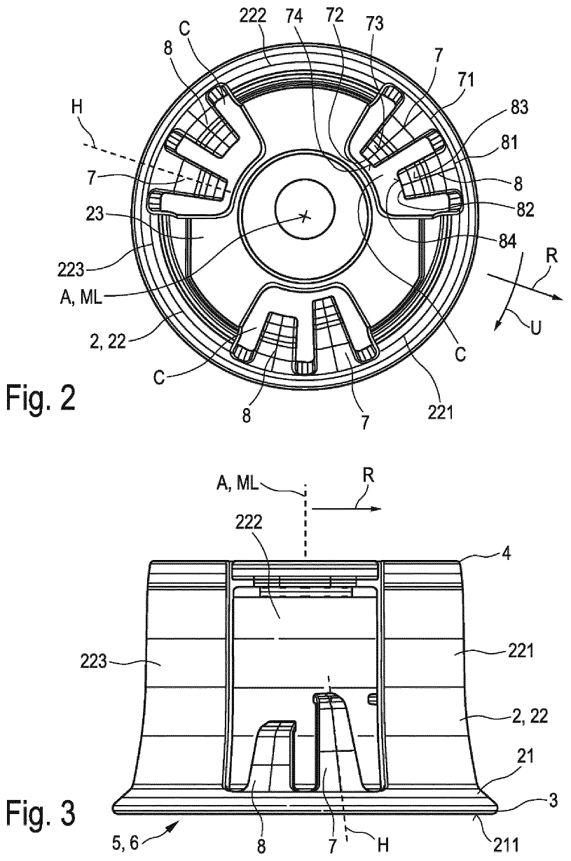

With respect to the drawing planes of FIGS. 1 and 3, the first housing end 3 can also be referred to as the lower housing end or housing underside. The second housing end 4 can accordingly be referred to as the upper housing end or housing top. The first housing end 3 and the second housing end 4 are arranged opposite each other along a central longitudinal axis ML (see FIGS. 2 and 3) oriented in the axial direction A. The housing 2 therefore extends in the axial direction A and/or along the central longitudinal axis ML.

The housing recess 5 is arranged between the two housing ends 3, 4. The housing recess 5 serves to partially receive the respective vial V1, V2.

The insertion opening 6 is arranged at one end of the housing 2, more precisely at the first housing end 3, and leads into the housing recess 5. For coupling to the adapter device 1, the relevant vial V1, V2 can be axially inserted, with its closure cap D1, D2 first, through the insertion opening 6 into the housing recess 5. As is shown in FIGS. 4 and 5, the housing recess 5 in each case receives at least an “upper” region of the vial V1, V2, which comprises the closure cap D1, D2 and the neck region N1, N2.

The plurality of spring arms 7, 8 are arranged offset in the circumferential direction of the housing 2 about the central longitudinal axis ML, each extending between a foot end 71, 81 and a latching end 72, 82. The foot ends 71, 81 are each firmly connected to the housing 2. By contrast, the latching ends 72, 82 are “free” and are used for latching with the respective vial V1, V2.

In the embodiment shown, the plurality of spring arms 7, 8 comprise first spring arms 7 and second spring arms 8. The first spring arms 7 are primarily used for coupling to the first vial V1. The second spring arms 8 are primarily used for coupling to the second vial V2. For this purpose, the first spring arms 7 and the second spring arms 8 are different, especially in terms of their length. Nevertheless, the first spring arms 7 and the second spring arms 8 are largely identical. Unless stated otherwise, features explained with respect to one of the first spring arms 7 also apply to the further first spring arms 7 and, mutatis mutandis, to the second spring arms 8. The same applies conversely to features that are explained with respect to one of the second spring arms 8.

In the embodiment shown, (exactly) three first spring arms 7 are present and are offset from one another, in each case by 120° about the central longitudinal axis ML. The same applies to the second spring arms 8.

In embodiments not shown in the figures, only two first spring arms and two second spring arms or more than three spring arms of a kind are present, for example four, five, six or more first spring arms and a corresponding number of second spring arms.

The spring arms 7, 8 each extend between their foot end 71, 81 and their latching end 72, 82. Starting from the respective foot end 71, 81, the spring arms 7, 8 protrude inward in the radial direction R, i.e. in the direction toward the central longitudinal axis ML, and axially in the direction of the second housing end 4, as far as their respective latching end 72, 82. In other words, starting from their foot end 71, 81, the spring arms 7, 8 protrude in the axial insertion direction of the vial V1, V2 into the housing recess 5.

The function of the spring arms 7, 8 when coupling the adapter device 1 to the relevant vial V1, V2 is explained below:

For coupling the adapter device 1 to the first vial V1, the central longitudinal axis ML is oriented coaxially with respect to a longitudinal axis (without reference sign) of the first vial V1. The insertion opening 6 faces in the direction of the (first) closure cap D1. The first vial V1 is inserted, with its (first) closure cap D1 first, through the insertion opening 6 into the housing recess 5. In this case, the first spring arms 7 are deformed under the action of the closure cap D1. In particular, the first spring arms 7 are pressed elastically outward in the radial direction R. The latching ends 72 slide axially on a (first) jacket surface M1 of the closure cap D1, and finally they form-fittingly latch axially onto the closure cap D1 in the direction of the housing opening 6. In particular, the first latching ends 72 latch on and/or axially behind a front end B1 of the first closure cap D1 (see FIG. 4). In the coupled state, the first vial V1 is held, in the radial direction R, form-fittingly between the latching ends 72 of the plurality of first spring arms 7. A radial form-fit with the second spring arm 8 can be provided alternatively or additionally.

When the first vial V1 is inserted, its closure cap D1 is also guided axially past the latching ends 82 of the second spring arms 8. As will be explained in more detail, the second spring arms 8 are shorter than the first spring arms 7, and therefore the latching ends 82 of the second spring arms 8, with respect to the central longitudinal axis ML, are positioned radially further outward (see FIG. 2) and axially closer in the direction of the housing opening 6 (see FIG. 3). In a state with the adapter device 1 coupled to the first vial V1, which is shown in FIG. 4 and can also be referred to as the first coupling state, the latching ends 82 of the second spring arms 8 bear on the (first) neck region N1 of the first vial V1. This further stabilizes the coupling. The stabilization acts in particular in the radial direction R. A positive fit of the spring arms 8 with the first vial V1 in the axial direction A is not present here.

Alternatively, the adapter device 1 can be coupled to the second vial V2. The adapter device 1 is joined to the second vial V2 analogously to the way it is joined to the first vial V1. Reference is made to the above explanations. When the second closure cap D2 is inserted, it first slides on the latching ends 82 of the second spring arms 8, so that these are bent radially outward elastically. Upon further insertion, the second closure cap D2 also comes into contact with the latching ends 72 of the first spring arms 7, so that these too are bent radially outward elastically. As soon as the second closure cap D2 is axially inserted far enough into the housing recess 5, the second spring arms 8 spring back radially inward, as a result of which their latching ends 82 latch onto/with the second closure cap D2. Analogous to the latching connection between the first spring arms 7 and the first closure cap D1, the latching connection is form-fitting along the central longitudinal axis ML in the direction of the insertion opening 6, as a result of which withdrawal of the second vial V2 from the housing recess 5 is counteracted. In the coupled state, the second vial V2 is held form-fittingly in the radial direction R between the latching ends 82 of the plurality of second spring arms 8. A radial positive fit with the first spring arms 7 can be provided alternatively or additionally. In the (second) coupling state shown in FIG. 5, the latching ends 72 of the first spring arms bear elastically pre-tensioned on the (second) jacket surface M2 of the second closure lid D2. The elastic pre-tensioning acts radially inward. This provides additional stabilization of the coupling. This stabilization acts primarily in the radial direction. There is no axial form-fit of the first spring arms with the second vial 8.

In order to counteract unwanted decoupling, the housing 2 is closed all the way round at the axial height of the foot ends 71, 81 in order to form a ring portion 21.

The ring portion 21 counteracts a radial yielding movement of the foot ends 71, 81 under a pressure load and/or longitudinal bending load acting in the longitudinal direction of the spring arms 7, 8. Such loading of the spring arms 7, 8 takes place upon attempted decoupling, i.e. withdrawal of the relevant vial V1, V2, from the housing recess 5. In this case, the respective closure cap D1, D2 presses axially in the direction of the insertion opening 6 onto the latching end 72, 82 of the respective spring arm 7, 8. The spring arms 7, 8 are thereby subjected to pressure along their longitudinal direction. At the same time, they undergo longitudinal bending. The ring portion 21 takes up the pressure load of the spring arms 7, 8 in the region of their foot ends 71, 81. Since the ring portion is closed all the way round in the circumferential direction U, the foot ends 71, 81 are not pressed radially outward for example, but instead are stabilized against such a yielding movement and/or deformation. This is in contrast to adapter devices known from the prior art, in which the housing is provided with a plurality of axial slots offset from one another in the circumferential direction.

In combination with the orientation of the spring arms 7, 8 protruding into the housing recess 5, the ring portion 21 also allows a kind of “self-locking” or “self-reinforcing effect”.

This effect additionally counteracts unwanted withdrawal of the vial V1, V2 from the adapter device 1. The reason is that, as a result of the above-described longitudinal bending of the spring arms 7, 8 under the action of the respective closure cap D1, D2, the respectively latched latching ends 72, 82 move radially inward on an imaginary arc-shaped bending line. In this way, the respective latching ends 72, 82 are pressed inward in the radial direction R onto the respective neck portion N1, N2, as a result of which unwanted decoupling is additionally counteracted.

Further features, in particular of the spring arms 7, 8, are explained below. As has already been mentioned, explanations regarding one of the first spring arms 7 also apply, unless otherwise stated, to the further first spring arms and the second spring arms, and vice versa.

Referring to FIG. 1, the latter shows that the spring arms 7, 8 each have a cross-sectional area Q. The cross-sectional area Q is indicated by hatching in FIG. 1. The cross-sectional area Q is at its maximum in the region of the respective foot end 71, 81. As a result, the spring arms 7, 8 are able to withstand maximum loading at the foot end. This counteracts mechanical failure of the spring arms 7, 8 in the region of the foot ends 71, 81. In particular, this avoids the spring arms 7, 8 buckling and/or being plastically deformed at the foot end.

The spring arms 7, 8 each have a main axis of extent H (see FIG. 1). The main axis of extent H can also be referred to as the longitudinal axis and defines an orientation of the main extent of the spring arms 7, 8. The main axis of extent H is oriented obliquely with respect to the central longitudinal axis ML. In the embodiment shown, the main axis of extent H lies in a plane which is spanned by the axial direction A and the radial direction R and runs through the central longitudinal axis ML. Starting from an imaginary orientation parallel to the central longitudinal axis ML, the main axis of extent H is inclined radially inward by an angle (without reference sign) of between 10° and 50°. In the embodiment shown, the angle is between 20° and 40°, in particular about 30°.

In the embodiment shown, the spring arms 7, 8 have a non-constant cross section and thus a variable cross-sectional area Q. In other words, the cross-sectional area Q changes along the main axis of extent H. The cross-sectional area Q decreases in the direction of the latching end 72, 82. This decrease is preferably continuous and/or monotonous.

In the embodiment shown, the latching ends 72, 82 are each curved radially inward. Therefore, in the region of their respective latching end 72, 82, the spring arms 7, 8 are inclined more strongly in the direction of the central longitudinal axis ML than, for example, in a central region (without reference sign) which is arranged between the respective foot end 71, 81 and the latching end 72, 82.

Furthermore, the latching ends 72, 82 each have a first contact surface 73, 83 and a second contact surface 74, 84 (see FIG. 2).

The first contact surface 73 of the first spring arms 7 is oriented at least predominantly axially in the direction of the second housing end 4. The same applies to the first contact surface 83 of the second spring arms 8. The first contact surface 73, 83 serves for axial form-fit engagement with the lower end face B1, B2 of the respective vial V1, V2 (see FIGS. 4 and 5). In the first coupling state, the end face B1 of the first closure cap D1 rests on the first contact surfaces 73 of the first spring arms 7. In the second coupling state, the end face B2 of the second closure cap D2 rests on the first contact surfaces 83 of the second spring arms 8.

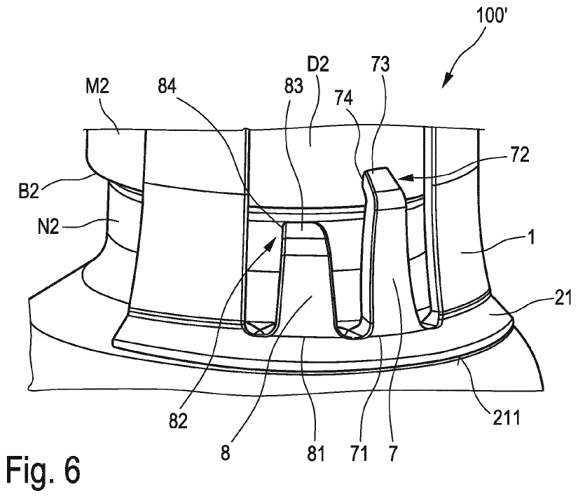

The second contact surface 74 of the first spring arms 7 is at least predominantly oriented radially inward. The same applies to the second contact surface 84 of the second spring arms 8. In the first coupling state (see FIG. 4), the second contact surfaces 84 of the second spring arms 8 rest on the neck region N1 of the first vial V1. In the second coupling state (FIG. 5), the second contact surfaces 74 of the first spring arms 7 rest, in a radially inwardly biased manner, on the jacket surface M2 of the second closure cap D2. This is shown in detail in FIG. 6; the state shown in FIG. 6 cannot be seen in detail in FIG. 5.

The first contact surface 73, 83 and the second contact surface 74, 84 are each flat in the present case.

In an embodiment not shown in the figures, the latching ends of the spring arms have a different design. For example, a rounded or even spherical design can be provided instead of the contact surfaces that have been explained.

In the embodiment shown, the housing 2 has a housing wall 22 extending between the first housing end 3 and the second housing end 4. The housing wall 22 extends in the axial direction A and in the circumferential direction U. An unspecified wall thickness of the housing wall 22 extends in the radial direction R. In the embodiment shown, the housing 2 and/or the housing wall 22 has a cylindrical basic shape.

The housing wall 22 in the present case has a plurality of recesses C offset from one another in the circumferential direction U. The recesses C divide the housing wall 22 into a plurality of wall portions 221, 222, 223. In the embodiment shown, there are (exactly) three recesses C and therefore a corresponding number of wall portions 221, 222, 223.

The recesses C in the present case extend substantially over a total axial height/length of the housing wall 22.

In the present case, the recesses C and thus also the wall portions 221, 222, 223 are uniformly offset, so that the present number results in an offset of 120° about the central longitudinal axis ML.

The recesses C are bridged in the circumferential direction U by the ring portion 21. In other words, the ring portion 21 connects the wall portions 221, 222, 223 to one another in the circumferential direction.

The housing wall 22 limits the housing recess 5 in the radial direction R. The recesses C extend in the radial direction R from the outside inward into the housing recess 5.

In the embodiment shown, the spring arms 7, 8 are arranged in pairs in the recesses C. In particular, a first spring arm 7 and a second spring arm 8 are provided for each recess C. The arrangement of the spring arms 7, 8 in the recesses C allows improved visibility of the latching ends 72, 82. This allows medical personnel to easily determine whether or not there is correct coupling.

In the embodiment shown, the wall portions 221, 222, 223 in the region of the first housing end 4 are connected to one another by a front wall 23 of the housing 2. The front wall 23 extends radially and is oriented parallel to the insertion opening 6 and/or the ring portion 21. The recesses C extend in the radial direction inward into the front wall 23. The front wall 23 is optional and is not present in all embodiments.

In the embodiment shown, the ring portion 21 forms the first housing end 3. At the same time, the ring portion 21 delimits the insertion opening 6. In addition, the ring portion 21 has a set-down surface 221. The set-down surface 221 is axially oriented. The adapter device 1 can be placed, with the set-down surface 211 first, on a suitable horizontal support, for example a table. In the coupled state, the set-down surface 211 bears on an unspecified portion of the relevant vial V1, V2 (see FIGS. 4, 5 and 6).

In the embodiment shown, the adapter device 1 is manufactured in one piece. The spring arms 7, 8 are thus integral components of the housing 2. In the present case, the device is manufactured from plastic. In other embodiments, it can be manufactured in multiple parts.

1.-10. (canceled)

11. An adapter device for coupling to a medical vial that is closed with a closure cap, the adapter device comprising:
a housing comprising:
a first housing end;
a second housing end lying opposite the first housing end along a central longitudinal axis oriented in an axial direction;
a housing recess arranged between the first housing end and the second housing end; and
an insertion opening arranged at the first housing end and serving for axial insertion of the medical vial into the housing recess; and
a plurality of spring arms arranged in the housing recess in a manner offset from one another in a circumferential direction about the central longitudinal axis,
each spring arm extending between a foot end, which is firmly connected to the housing, and a latching end, which is configured to latch with the closure cap,
each spring arm extending from the foot end to the latching end in a radial direction toward the central longitudinal axis and in an axial direction toward the second housing end,
the plurality of spring arms being deformable by an axial insertion of the medical vial into the housing recess, so as to form-fittingly latch the latching ends axially with the closure cap toward the insertion opening, and
the housing being closed circumferentially at an axial height of the foot ends in order to form a ring portion.

12. The adapter device according to claim 11, wherein each spring arm has a maximum cross-sectional area at the foot end.

13. The adapter device according to claim 11, wherein:
each spring arm has a length and a cross-sectional area that varies over the length, and
the cross-sectional area tapers along the length from the foot end towards the latching end.

14. The adapter device according to claim 11, wherein each spring arm has a main axis of extent which, starting from an imaginary alignment oriented parallel to the central longitudinal axis, is inclined radially inward by an angle of between 10° and 50°.

15. The adapter device according to claim 11, wherein:
the latching ends are each bent radially inwardly,
each latching end has a first contact surface at least predominantly oriented axially toward the second housing end, and
each latching end has a second contact surface at least predominantly oriented radially toward the central longitudinal axis.

16. The adapter device according to claim 11, wherein the ring portion forms the first housing end, delimits the insertion opening, and has a set-down surface at an end face for setting the medical vial down.

17. The adapter device according to claim 11, wherein:
the housing has a housing wall extending between the first housing end and the second housing end,
the housing wall has a plurality of recesses offset from one another in the circumferential direction,
the plurality of recesses divide the housing wall into a plurality of wall portions, and
the plurality of recesses are bridged by the ring portion in a region of the first housing end, with the plurality of spring arms being arranged in the plurality of recesses.

18. The adapter device according to claim 11, wherein:
the plurality of spring arms comprise first spring arms and second spring arms different from the first spring arms,
the first spring arms are configured to latch with a first vial of a first size, and
the second spring arms are configured to latch with a second vial of a second size larger than the first size.

19. The adapter device according to claim 18, wherein the first spring arms are longer than the second spring arms, as a result of which the latching ends of the first spring arms are positioned closer to the central longitudinal axis and closer to the second housing end than the latching ends of the second spring arms.

20. A medical vial assembly comprising:
an adapter device according to claim 18; and
at least one of:
a first vial of a first size; and
a second vial of a second size larger than the first size,
wherein:
the adapter device is coupled to the first vial in a first coupling state,
the adapter device is coupled to the second vial in a second coupling state different from the first coupling state,
in the first coupling state, the latching ends of the first spring arms are latched with the closure cap of the first vial and the latching ends of the second spring arms bear against a portion of the first vial spaced axially away from the closure cap toward the insertion opening, and
in the second coupling state, the latching ends of the second spring arms are latched with the closure cap of the second vial and the latching ends of the first spring arms are elastically spring-loaded radially outwardly under action of the closure cap and bear, in a radially inwardly biased state, on a jacket surface of the closure cap of the second vial.
